(19) United States
(12) Patent Application Publication
(10) Pub. No.: US 2002/0096187 A1
(43) Pub. Date: Jul. 25, 2002

(54) Cleaner for cleaning a capillary tube for use in a wire bonding tool

(75) Inventors: Kouji Kuwata, Kumamoto (JP); Mitsuki Arita, Kumamoto (JP)

Correspondence Address: Patent Group, Hutchins, Wheeler & Dittmar, 101 Federal Street, Boston, MA, 02110, US

(73) Assignee: NEC Corporation

(21) Appl. No.: 10/054,559

(22) Filed: Jan. 22, 2002

(30) Foreign Application Priority Data
Jan. 24, 2001 (JP) 2001-015590

(51) Int. Cl. B08B 3/12

(52) U.S. Cl. 134/1; 134/6; 134/184; 134/115 R

(57) ABSTRACT

A method for cleaning a capillary tube for use in a wire bonding tool includes the step of applying an ultrasonic wave to the capillary tube, with the tip of the capillary tube being immersed in a cleaning solution, and with a tungsten wire being inserted in the capillary tube. Before the cleaning step, the capillary tube is ground by an abrasive sheet, with the capillary tube being empty.

### BACKGROUND OF THE INVENTION

(a) Field of the Invention

The present invention relates to a cleaner for cleaning a capillary tube for use in a wire bonding tool and, more particularly, to a cleaner having a simple structure for cleaning a capillary tube for guiding therethrough a bonding wire.

The present invention also relates to a method for cleaning such a capillary tube.

(b) Description of the Related Art

In a fabrication process of semiconductor devices (ICs), a wire bonding tool is used for electrically bonding together an electrode pad of a semiconductor pellet and a lead of a lead frame, which mounts thereon the semiconductor pellet. In the bonding step, a bonding tool such as wedge tool or capillary tube guides the metallic wire to press the metallic wire onto the lead frame and the electrode pad for the bonding step.

After the wire bonding tool is used for bonding several hundred thousands of times to one-million times, for example, some impurities or foreign materials separated from or deposited on the surface of the metallic wire are attached onto parts, such as a capillary tube, of the bonding tool. If the capillary tube is used in the case of foreign materials being attached onto the same, the frictional resistance of the capillary tube with respect to the metallic wire increases, thereby generating a malfunction wherein length of the metallic wire passing the tip of the capillary tube at a time varies widely.

Patent Publication JP-A-8-264584 describes a bonding tool which removes the malfunction as described above. FIG. 1 shows the described bonding tool, which includes a horn 12 movable with respect to a pair of carriage rails 11 and a wedge tool 13 extending with respect to the extending direction of a bonding horn 12. A metallic wire 15 extending through a guide hole 12a formed in the bonding horn 12 is guided at the tip portion of the metallic wire 15 in the axial direction of the bonding horn 15 by a guide groove 13a formed on the bottom portion of the wedge tool 13. The bonding tool connects together a semiconductor pellet 17 and a lead frame 10 on the carriage rails 11 while pressing the metallic wire 15 guided by the guide groove 13a sequentially onto the pellet 17 and the lead frame 10.

The bonding tool includes a sliding member 19 having a protrusion 19a aligned with the guide groove 13a as viewed from the axial direction of the bonding horn 12. If the tip portion of the wedge tool, especially the guide groove 13a, is attached with foreign materials during the iterated bonding operations, the tip portion of the wedge tool is shifted toward and contacted with the protrusion 29a of the sliding member 29, after the bonding operation is stopped and the metallic wire 15 is pulled back from the guide groove 13a. Thereafter, the wedge tool 13 is moved reciprocally with respect to the sliding member 29 for cleaning the guide groove 13a.

In the bonding tool described in the above publication, although the wedge tool is simple in the structure thereof, the wedge tool is not suited to a soft metallic wire such as a gold wire.

Utility Model Publication JP-A-61-144644 describes another wire bonding tool shown in FIG. 2. The bonding tool includes a pair of carriage rails 21 for guiding lead frames, an X-Y table 22 disposed in the vicinity of the carriage rails 21, and a tool body 26 mounted on the X-Y table 22 and having thereon a bonding horn 25 supporting a capillary tube 23 at the tip of the bonding horn 25. A cleaning tank 27 is disposed in the vicinity of the carriage rails 21 for cleaning the capillary tube 23. In operation for cleaning the capillary tube 23, the X-Y table 22 moves the capillary tube 23 toward the cleaning tank 27.

In the bonding tool having the capillary tube 23, a metallic wire 30 is supplied for bonding from a wire drum 29, passing through the capillary tube 23. After a specified number of bonding operations, the metallic wire 30 is pulled out from the capillary tube 23, and the X-Y table 22 moves the bonding horn 25 toward the cleaning tank 27. The capillary tube 23 is then immersed in the cleaning solution received in the cleaning tank 27, to be subjected to vibration by using a ultrasonic wave for cleaning.

In the bonding tool described in JP-A-61-144644, the cleaning step effected by the cleaning solution and the ultrasonic wave is insufficient for cleaning a capillary tube having a small diameter. Especially, if the bonding tool is used for a fine-pitch-ball bonding technique, for example, the foreign materials are not effectively removed without using a cleaning alkali chemical, which is not suited in a fabrication process of semiconductor devices. In addition, the cleaning tank 27 is sometimes an obstacle against a smooth bonding operation depending on the direction of the movement of the bonding horn 25.

### SUMMARY OF THE INVENTION

In view of the above problems in the conventional techniques, it is an object of the present invention to provide a simple cleaner and a simple method, each of which effectively cleans a capillary tube for use in a wire bonding tool.

The present invention provides a cleaner for cleaning a capillary tube for use in a wire bonding tool, the cleaner including: a cleaning wire to be inserted in the capillary tube; a cleaning tank for receiving therein a cleaning solution; and an ultrasonic wave generator for applying an ultrasonic wave to the capillary tube, with a tip portion of the capillary tube being immersed in the cleaning solution, and with the cleaning wire being inserted at least in the tip portion of the capillary tube.

The present invention also provides a method for cleaning a capillary tube for use in a wire bonding tool, the method including the step of: applying an ultrasonic wave to the capillary tube, with a tip portion of the capillary tube being immersed in a cleaning solution, and with a cleaning wire being inserted at least in the tip portion of the capillary tube.

In accordance with the cleaner and the method of the present invention, the ultrasonic wave in association with the cleaning wire and the cleaning solution effectively removes the foreign materials from the capillary tube, without detaching the capillary tube from a bonding horn.

The above and other objects, features and advantages of the present invention will be more apparent from the following description, referring to the accompanying drawings.

### BRIEF DESCRIPTION OF THE DRAWINGS

FIG. 1 is sectional view of a conventional wire bonding tool.

FIG. 2 is a top plan view of another conventional wire bonding tool.

FIG. 3 is a perspective view of a wire bonding tool to be cleaned by a cleaner according to an embodiment of the present invention.

FIG. 4 is a perspective view of the wire bonding tool of FIG. 3 in combination with the cleaner.

FIG. 5 is a flowchart of the operation of a capillary tube and a process for cleaning the same according to an embodiment of the present invention.

FIG. 6 is a perspective view of the capillary tube shown in FIG. 3 during grinding the tip of the capillary tube.

FIG. 7 is a longitudinal-sectional view of the capillary tube of FIG. 6 suffering from clogging.

FIG. 8 is a perspective view of the capillary tube subjected to cleaning by the cleaner of the present embodiment.

FIG. 9 is a longitudinal-sectional view of the capillary tube shown in FIG. 8, showing the detail of the tip thereof.

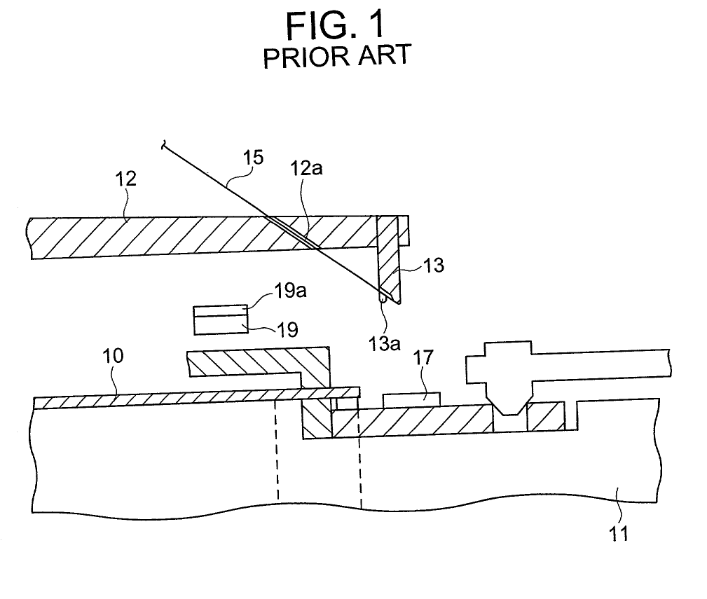

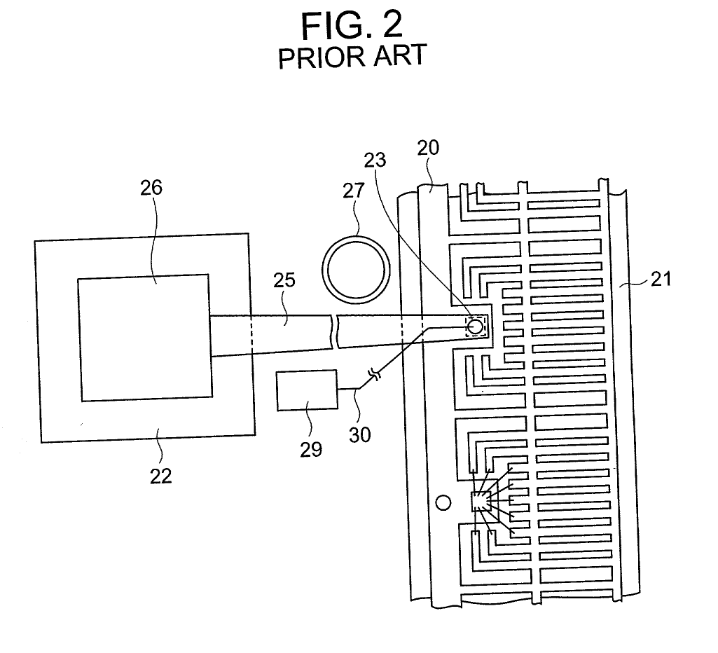

### PREFERRED EMBODIMENTS OF THE INVENTION

Now, the present invention is more specifically described with reference to accompanying drawings, wherein similar constituent elements are designated by similar reference numerals.

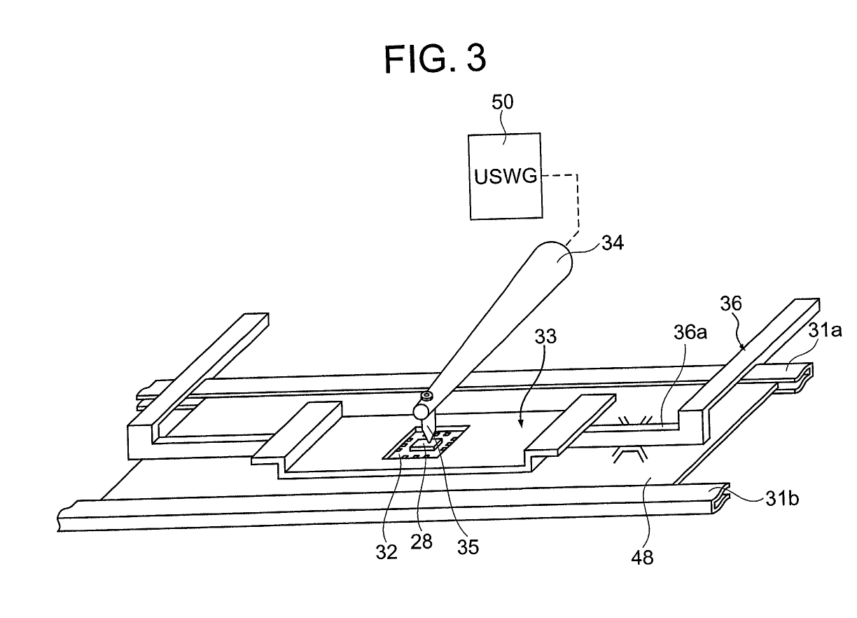

Referring to FIG. 3, there is shown the configuration of a wire bonding tool having a capillary tube 34 to be cleaned by a cleaner (not shown) according to an embodiment of the present invention. The bonding tool includes a pair of carriage rails 31a and 31b along which a lead frame 48 is guided, a presser plate 33 for pressing the lead frame 48, and a bonding horn 34 supported by an X-Y table (not shown) by mans of a pair of support bars 36. The presser plate 33 has an opening 32 for exposing a semiconductor pellet 28 disposed on the lead frame 48. The bonding horn 34 extends perpendicular to the carriage rails 31a and 31b, and supports at the tip thereof a capillary tube 35.

The wire bonding tool further includes an ultrasonic wave generator (USWG) 50 for applying a ultrasonic wave to the capillary tube 35 by way of the bonding horn 34 during a bonding operation of the bonding tool, as well as during a cleaning operation for the capillary tube 35 for a specific time interval.

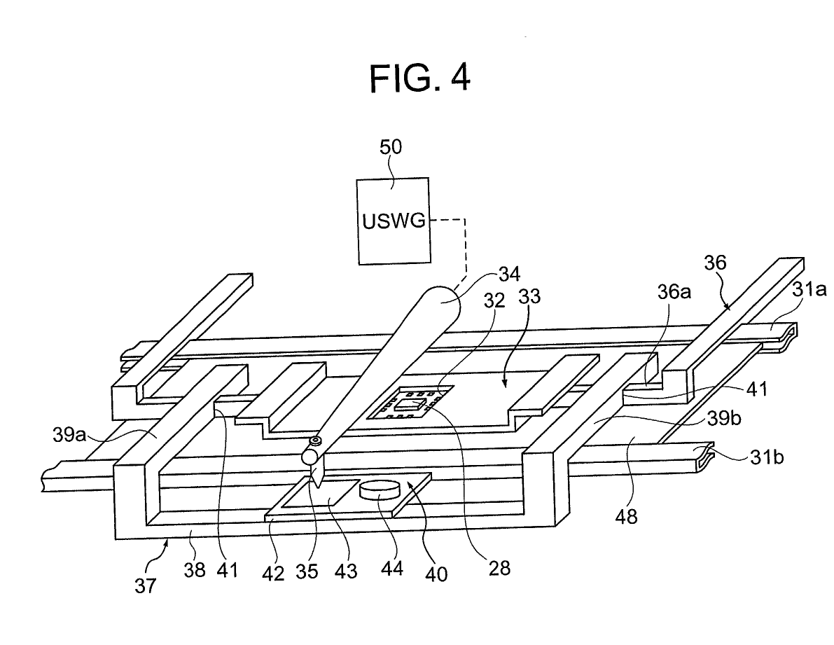

Referring to FIG. 4 showing the cleaner 37 in combination with the wire bonding tool of FIG. 3, the cleaner 37 includes a base bar 38 extending parallel to the carriage rails 31a and 31b, a pair of L-shaped members 39a extending perpendicular to the carriage rails 31a and 31b from both the ends of the base bar 38 toward the support bars 36, and a cleaning member 40 supported by the base bar 38 at the center thereof.

Each of the L-shaped members 39a and 39b has a cut-out 41 which engages with the support bar 36 for supporting the same.

The cleaning member 40 includes a mounting plate 42 fixed onto the base bar 38, an abrasive sheet 43 such as made of wrapping film fixed on the mounting plate 42, and a cleaning tank 44 disposed on the mounting plate 42 in the vicinity of the abrasive sheet 43. The cleaning tank 44 is filled with a cleaning solution such as alcohol.

The cleaner 37 as described above is disposed separately from the wire bonding tool during operation of the wire bonding tool, and is combined therewith before cleaning the capillary tube 35. In the combination, the self-weight of the cleaner 37 allows the cut-outs 41 of the L-shaped members 39a and 39b to engage firmly with the support bar 36, which supports the cleaner 37.

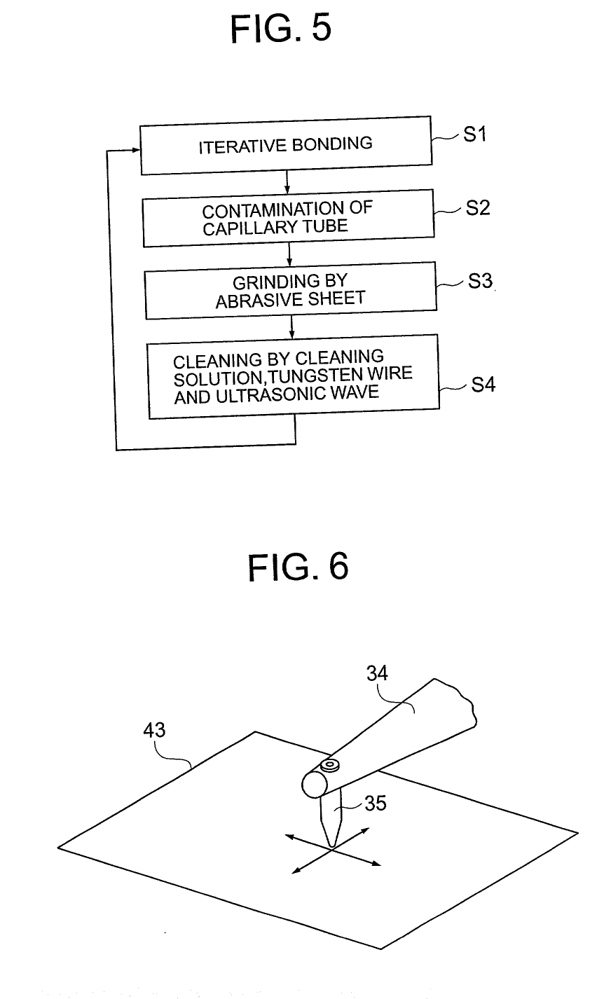

Referring to FIG. 5, in iterative operations of the wire bonding tool, such as several hundred thousands of times to one-million times, in step S1, the capillary tube 35 eventually suffers from an increase of the frictional resistance due to contamination thereof in step S2. The bonding operation is then stopped for bonding, the metallic wire is pulled out from the capillary tube 35, and the cleaner is combined with the wire bonding tool 37. Subsequently, by using a manual operation, the bonding horn 34 is shifted toward above the front side of the presser plate 33 while being somewhat raised, whereby the tip of the capillary tube 35 is located on the abrasive sheet 40 of the cleaning member 40.

Referring to FIG. 6, the tip of the capillary tube 35 is in contact with the abrasive sheet 43 after the bonding horn 34 is lowered by a manual operation. The bonding horn 34 is then moved reciprocally in the X- and Y-directions, thereby grinding the tip or tip portion of the capillary tube 35 in step S3.

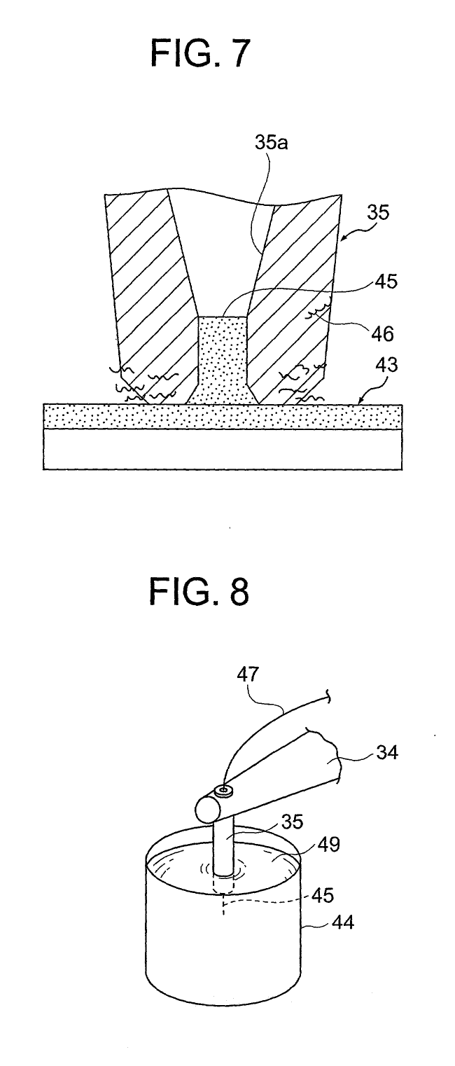

Referring to FIG. 7 showing the detail of the state in step S3 where the capillary tube 35 is being ground by the abrasive sheet 43, although most of the foreign materials 46 attached onto the tip of the capillary tube 35 are removed, the particles 45 generated by the grinding are thrust into the capillary tube 35. The particles 45 often clog the capillary tube 35. These particles 45 are removed, as illustrated in FIG. 8, by immersing the tip of the capillary tube 35 in the cleaning solution 49 while using a tungsten wire 47 (step S4).

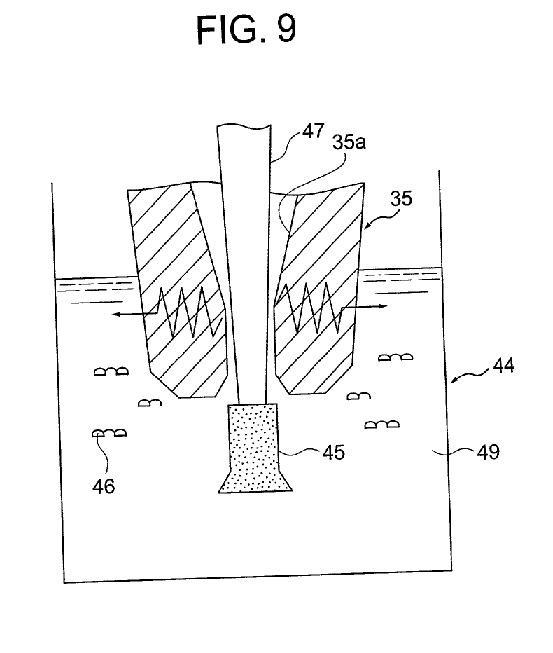

More specifically, referring to FIG. 9 illustrating the detail of the state shown in FIG. 8, after the capillary tube 35 is ground by the abrasive sheet in step S3, the capillary tube 35 is immersed in the cleaning solution 49. Subsequently, an operator inserts the tungsten wire 47 into the capillary tube 35, the tungsten wire having a diameter somewhat smaller than the diameter of the capillary tube 35. The operator thrusts to remove the particles 45 including the remaining foreign materials 46 out of the tip of the capillary tube 35 by using the tungsten wire 47 together with the cleaning solution and a ultrasonic wave to eliminate the clogging of the capillary tube 35. The ultrasonic wave applied to the capillary tube 35 from the ultrasonic wave generator 50 allows the tungsten wire 47 to slide relative to the inner surface of the capillary tube 35 to remove the remaining particles and contamination within the capillary tube 35. Thus, this step allows the tip of the capillary tube 35 to be effectively cleaned.

Since the cleaning process described above allows the inner and outer surfaces of the vicinity of the tip of the capillary tube 35, with the capillary tube 35 being attached to the bonding horn 34, removal and attachment of the capillary tube 35 for the cleaning step as well as subsequent adjustment thereof for the working piece can be obviated. This raises the throughput of the bonding process.

The above process uses, for example, the following abrasive conditions:

the pressing load at 392 mN or 40 gram-weight applied to the capillary tube 35;

the grain size of the abrasive at 0.3 μm in diameter; and

the total grinding length at 40 mm for the tip of the capillary tube 35 which moves in the X- and Y-directions,

as well as the following cleaning conditions;

electric power at 250 mW for the ultrasonic wave applied to the capillary;

the time length for 10 seconds for application of the ultrasonic wave; and

the outer diameter at 40 μm for the tungsten wire.

As described above, the cleaning process of the present embodiment is such that the capillary tube 35 is moved in the X- and Y-directions for grinding the tip of the capillary tube 35, with the capillary tube being in contact with the abrasive sheet 43 by the function of the bonding horn. However, the cleaning process of the present invention may be varied as desired. For example, the abrasive sheet 43 may be rotated in the horizontal plane for grinding the tip of the capillary tube 35, with the abrasive sheet 43 being in contact with the capillary tube 35.

Since the above embodiment is described only for an example, the present invention is not limited to the above embodiment and various modifications or alterations can be easily made therefrom by those skilled in the art without departing from the scope of the present invention.

What is claimed is:

1. A method for cleaning a capillary tube for use in a wire bonding tool, the method comprising the step of:
applying an ultrasonic wave to the capillary tube, with a tip portion of the capillary tube being immersed in a cleaning solution, and with a cleaning wire being inserted at least in the tip portion of the capillary tube.

2. The method as defined in claim 1, further comprising, prior to said applying step, the step of grinding the tip portion of the capillary tube by using an abrasive sheet, with at least the tip portion of the capillary tube being empty.

3. The method as defined in claim 2, wherein said grinding step comprises the step of moving the capillary tube.

4. The method as defined in claim 2, wherein said grinding step comprises the step of rotating the abrasive sheet.

5. The method as defined in claim 1, wherein the cleaning wire is made of tungsten.

6. A cleaner for cleaning a capillary tube for use in a wire bonding tool, the cleaner comprising:
a cleaning wire to be inserted in the capillary tube;
a cleaning tank for receiving therein a cleaning solution; and
an ultrasonic wave generator for applying an ultrasonic wave to the capillary tube, with a tip portion of the capillary tube being immersed in the cleaning solution, and with the cleaning wire being inserted at least in the tip portion of the capillary tube.

7. The cleaner as defined in claim 6, further comprising an abrasive sheet for grinding the tip portion of the capillary tube.

8. The cleaner as defined in claim 6, wherein the cleaning wire is made of tungsten.
